(19) United States
(12) Patent Application Publication
(10) Pub. No.: US 2002/0122435 A1
(43) Pub. Date: Sep. 5, 2002

(54) Scalable multi-channel frame aligner

(76) Inventors: Vishweshwara Mundkur, Bangalore (IN); Channapatna Srinivasa Rao Mohan, Bangalore (IN)

Correspondence Address: FENWICK & WEST LLP, TWO PALO ALTO SQUARE, PALO ALTO, CA, 94306, US

(21) Appl. No.: 09/750,735

(22) Filed: Dec. 28, 2000

(51) Int. Cl. H04J 3/06

(52) U.S. Cl. 370/503; 370/429

(57) ABSTRACT

An offline frame alignment circuit can simultaneously achieve frame alignment for a large number of TDM streams (i.e. channels) within a required amount of time (e.g. 15 ms for ESF). The Multi-channel Frame Aligner (MCFA) uses a high speed system clock independent of the individual line clocks to perform frame alignment for each of the channels. The MCFA includes a framer memory to store the alignment states of all possible framing bit candidates for all channels. The MCFA polls each channel to determine if frame alignment is requested, and if so, if data from the associated channel is available. A state machine in the MCFA compares the received data with the expected framing bits and adjusts the stored alignment states accordingly. All framing bit candidates are processed in parallel leading to fast alignment times. The MCFA architecture can be adapted for any of a plurality of channels and framing formats merely by adjusting the speed of the MCFA system clock and capacity and arrangement of data states in the framer memory.

### FIELD OF THE INVENTION

This invention relates generally to frame alignment in a digital communications system, and more particularly, to a method and apparatus for performing frame alignment for a scalable plurality of communications channels.

### BACKGROUND OF THE INVENTION

The demand for telecommunications services continues to grow. With this growing demand for services comes the need for increased capacity, and telecommunications companies are scrambling to keep up. One way to handle increased capacity is to multiplex a plurality of communications channels onto higher-bandwidth channels. Thus, by adding a single high-bandwidth channel, many individual communications channels can be added and services can be increased dramatically.

FIG. 1 is a block diagram illustrating a conventional communications system. As shown in FIG. 1, for transmission over a high-capacity transmission media 102 such as a fiber optic cable or trunk line (and generally over long distances), transmit side 104 includes components for multiplexing multiple DS0 channels (each capable of carrying a separate PSTN voice call, for example). As shown in this example, multiple DS0 channels are multiplexed onto a DS1 channel by channel banks 106, and multiple DS1 channels can be further multiplexed onto higher order channels (e.g. DS3 and higher) by mutliplexers 108 for transmission over the media. Where necessary, further conversion and processing may be performed for different types of media (e.g. conversion to optical media and formats such as OC-3 to OC-192). Receive side 110 includes components 112, 114 for demultiplexing the received higher order channels onto DS1 channels and then further into DS0 channels, respectively.

Generally, time division multiplexing (TDM) techniques are used to multiplex the multiple DS0 channels onto higher order channels such as DS1. In a time division multiplexed scheme, each DS1 bit stream is serially transmitted in frames, with each frame containing a plurality of bits for each DS0 channel. Frame synchronization or frame alignment is the process that forces the transmitter and receiver to agree on the timing between the two systems, and thus allows the receiver to de-multiplex the individual DS0 channels from the received DS1 bit stream. Framing is performed on the transmit side by inserting one or more framing bits into the bit stream at predetermined intervals. A typical example is found in the North American 24 channel DS1 extended superframe format (ESF). In DS1 ESF framing, one frame bit is inserted for every 192 data bits (i.e. 8 bits×24 DS0 channels) at a frame rate of 8 kHz. A predetermined sequence of a frame bit pattern is transmitted at some or all of the Frame Bit positions. In the receiver, a frame alignment circuit detects this frame bit sequence and uses the frame alignment to recover the data bits for the individual DS0 channels from the data stream.

According to ANSI T.107 (Digital Hierarchy—Formats and Specifications) Standards, an extended DS1 framing format (ESF) is defined in which the frame bits are used for cyclic redundancy check bits and a maintenance channel, as well as for frame synchronization. In the extended framing format, the framing bits containing the framing pattern sequence (FPS) are sent only once in every fourth frame, every 772 bits. Six successive framing bits forming the FPS (e.g. the sequence 001011) are thus transmitted over 24 frames called superframes. The superframe interval repeats every 3 milliseconds.

The framing bits and their positions in the superframe are shown in Table 1.

TABLE 1
DS1 Extended Superframe Format.

| Frame No. | Bit No. | FPS | CRC | FDL |
|---|---|---|---|---|
| 1 | 0 | — | — | M1 |
| 2 | 193 | — | C1 | — |
| 3 | 386 | — | — | M2 |
| 4 | 579 | 0 | — | — |
| 5 | 772 | — | — | M3 |
| 6 | 965 | — | C2 | — |
| 7 | 1158 | — | — | M4 |
| 8 | 1351 | 0 | — | — |
| 9 | 1544 | — | — | M5 |
| 10 | 1737 | — | C3 | — |
| 11 | 1930 | — | — | M6 |
| 12 | 2123 | 1 | — | — |
| 13 | 2316 | — | — | M7 |
| 14 | 2509 | — | C4 | — |
| 15 | 2702 | — | — | M8 |
| 16 | 2895 | 0 | — | — |
| 17 | 3088 | — | — | M9 |
| 18 | 3281 | — | C5 | — |
| 19 | 3474 | — | — | M10 |
| 20 | 3667 | 1 | — | — |
| 21 | 3860 | — | — | M11 |
| 22 | 4053 | — | C6 | — |
| 23 | 4246 | — | — | M12 |
| 24 | 4439 | 1 | — | — |

FPS - Frame Pattern Sequence
CRC - Cyclic Redundancy Check
FDL - Facility Data Link

Thus, frame alignment requires detection of the frame pattern sequence (FPS) in each of the above bit position spaced apart by 772 bits in a data stream. Since the data stream is subjected to bit errors during transmission, however, reliable frame detection may require the detection of framing bits over several frames or superframes. A further requirement is that the frame aligner should reliably align in the presence of data errors that may also affect the frame bit pattern. A common requirement for ESF is that frame alignment should be achieved within 15 ms. Since there is always a finite probability of random data mimicking the frame alignment pattern, the requirement is usually stated in terms of finding a frame alignment within a certain amount of time and probability of correctness, for example, within 15 ms and a 99% probability that no data errors are present. A confirmation process often follows the frame alignment process, where the frame alignment is confirmed by additional checks before being accepted as the correct alignment. A common confirmation technique used with the ESF format is to calculate the CRC with the provisional alignment and compare the calculated CRC with the actual CRC bits C1-C6 transmitted over the DS1 frame bits.

Once frame alignment is achieved, the framer continues to check the frame alignment pattern for correctness. If errors exceed a certain threshold, an Out of Frame (OOF) signal is declared and a search for a fresh alignment is started. It is often observed that OOF conditions are declared due to burst errors subjected on the data stream and not due to a genuine change in the frame alignment. To avoid frequent frame alignments that can cause a disruption in the data processing, an offline frame aligner is often used. The inline framer, on detecting an OOF condition, requests the offline framer for a fresh search for frame alignment. The inline framer continues with the old alignment. If the offline frame aligner detects the same alignment as earlier, the inline framer will not be disturbed. Thus only genuine changes or loss in alignment will affect the inline framer.

Conventional circuits used to implement inline and offline framers suffer from many problems. For example, to detect the frame pattern sequence (FPS) spread over 4632 bits, the data is clocked one bit at a time through a shift register, and a check is made at each bit position for the frame pattern sequence in bit positions spaced at 772 bits. A large shift register capable of storing several frames would be required to reliably and quickly detect the frame pattern sequence. However, implementing large shift registers on integrated circuits requires substantial chip area and leads to other difficulties.

The above problems are exacerbated when multiple channels are required. For example, handling multiple channels using conventional approaches requires completely duplicating the amount of circuitry required for one channel for each of the multiple channels. A scalable approach would be preferred.

### SUMMARY OF THE INVENTION

The present invention relates to an architecture and methodology for performing frame alignment that is scalable for any of a plurality of multiplexed channels, and is adaptable for any of a variety of framing formats.

In accordance with an aspect of the invention, an offline frame alignment circuit can simultaneously achieve frame alignment for a large number of TDM streams (i.e. channels) within a required amount of time (e.g. 15 ms for ESF). The Multi-channel Frame Aligner (MCFA) uses a high speed system clock independent of the individual line clocks to perform frame alignment for each of the channels. The MCFA includes a framer memory to store the alignment states of all possible framing bit candidates for all channels. The MCFA polls each channel to determine if frame alignment is requested, and if so, if data from the associated channel is available. A state machine in the MCFA compares the received data with the expected framing bits and adjusts the stored alignment states accordingly. All framing bit candidates are processed in parallel leading to fast alignment times. The MCFA architecture can be adapted for any of a plurality of channels and framing formats merely by adjusting the speed of the MCFA system clock and capacity and arrangement of data states in the framer memory.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a block diagram illustrating a multiplexing scheme in a conventional communications system;

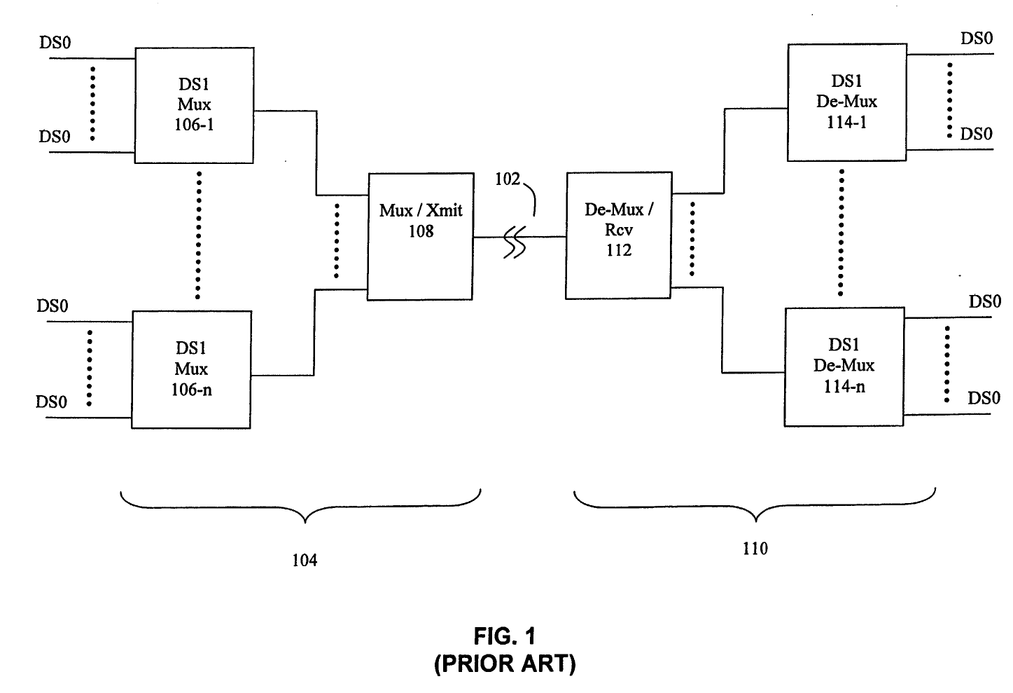

FIG. 2 is a block diagram of an example frame alignment architecture in accordance with an embodiment of the present invention;

FIG. 3 illustrates a framing scheme in a data stream that can be detected by the frame alignment architecture of the present invention;

FIG. 4 is a functional block diagram illustrating an example frame alignment method that can be implemented by the frame alignment architecture of the present invention;

FIG. 5 is a structural block diagram illustrating an example implementation of the frame alignment architecture of the present invention in accordance with an ESF framing scheme;

FIG. 6 is a state transition diagram illustrating an example of a state transition scheme that can be implemented by the frame aligner of the present invention;

FIG. 7 illustrates an example of data structures that can be used to implement storage of channel and data state information for a plurality of channels for which frame alignment can be performed by the frame aligner of the present invention;

FIG. 8 is a block diagram further illustrating an example of a frame alignment engine that can be included in the frame alignment architecture of the present invention illustrated in FIG. 5;

FIG. 9 is a state diagram illustrating an example of the processing flow in the frame alignment engine illustrated in FIG. 8 in accordance with an embodiment of the present invention; and

FIG. 10 is a block diagram further illustrating an example of a RAM interface block that can be included in the frame alignment engine illustrated in FIG. 8 in accordance with an embodiment of the present invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the implementation of certain elements of the present invention may be accomplished using software, hardware or any combination thereof, as would be apparent to those of ordinary skill in the art, and the figures and examples below are not meant to limit the scope of the present invention. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the known components referred to herein by way of illustration.

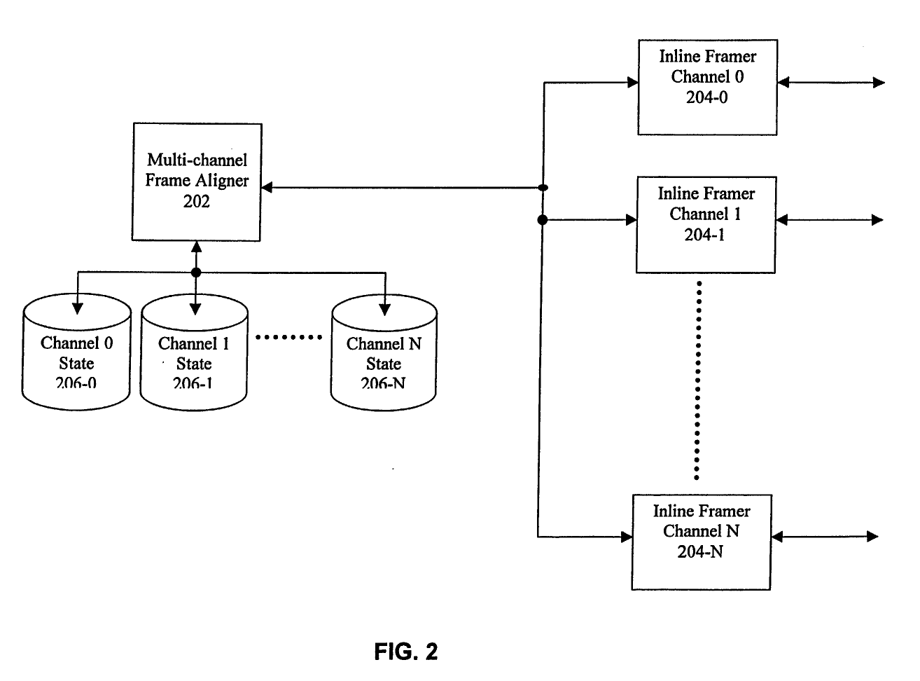

FIG. 2 is a block diagram illustrating an example architecture including a Multi-channel Frame Aligner (MCFA) in accordance with an embodiment of the present invention.

As shown in FIG. 2, MFCA 202 communicates with inline framers 204 for each channel 1 to N. MFCA 202 further maintains a state table 206 for each channel 1 to N. In operation, inline framers 204 continuously monitor the data stream for a corresponding channel for an out of frame (OOF) condition. When such a condition occurs, framers 204 request MCFA 202 to detect the presence of the framing pattern sequence (FPS) in the corresponding channel 1 to N. After receiving a request from a framer 204, MCFA 202 begins to collect data from the requesting channel. MCFA 202 then compares the collected data with the FPS to update a state maintained for that channel, and when frame alignment is detected, it is reported back to the requesting framer 204.

An advantage of the architecture of FIG. 2 is that the single MCFA 202 can simultaneously perform frame alignment for a plurality of channels 1 to N. In other words, even though channels 1to N and framers 204 are operating independently of each other, the MCFA 202, by maintaining state tables for all of them, can identify and maintain a frame alignment state for each channel simultaneously and independently. A further advantage is that the number of channels that can be processed by the single MCFA 202 can be easily extended by adding additional state tables, and also perhaps by increasing a processor clock speed, as will be described in more detail below. Further, the present architecture can be used to perform frame alignment for a variety of framing formats, such as DS1 SF, DS1 DDS, DS1 SLC-96, ITU-T G.704 based E1, which formats can be either pre-programmed or adjusted dynamically.

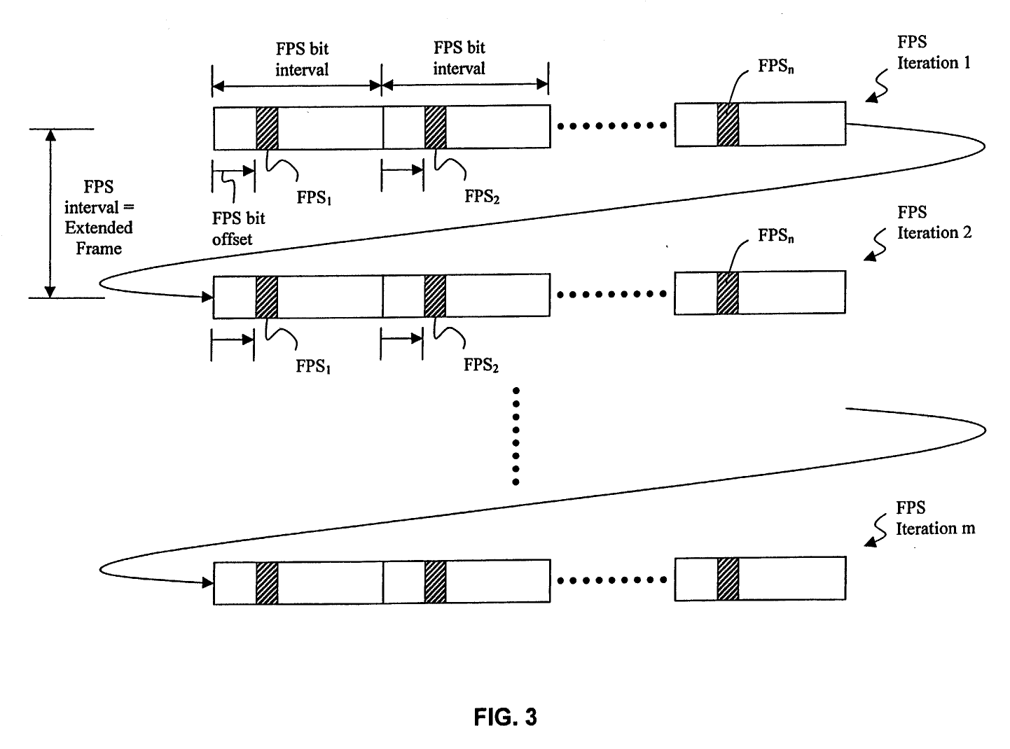

FIG. 3 further illustrates the data stream for a given channel. As shown in FIG. 3, within the data the entire FPS (comprising FPS bits FPS₁ to FPSₙ) will be repeated once per FPS interval. Generally, the FPS interval will coincide with an extended frame for the given frame format (e.g. six frames=an extended frame in the ESF format). FIG. 3 shows m iterations (FPS Iteration 1 to FPS Iteration m) of the FPS in a data stream for a given channel. For an unaligned data stream, the location of the FPS in the data stream is unknown. Accordingly, each bit of the FPS occurs at an arbitrary FPS bit offset within the data stream. However, it is known that a FPS bit will occur repeatedly at that same FPS bit offset after a known FPS bit interval in the data stream. For example, in an ESF framing scheme, a FPS bit will occur once every 772 bits in a data stream. Accordingly, for a given number of bits in an FPS bit interval, an FPS bit will occur at a constant FPS bit offset in each consecutive FPS bit interval of the data stream. It should be further apparent that an entire FPS will be received after n FPS bit intervals of the data stream have been received, although perhaps not beginning with the first FPS bit in the sequence.

As should be thus apparent from the above, one way to perform frame alignment is to determine the FPS bit offset, given an arbitrary starting point of collecting data from a data stream for a given channel. It should be further apparent that it may not be sufficient to simply collect data corresponding to one iteration of the FPS, because the starting bit in the FPS will be an arbitrary one of the FPS bits FPS₁ to FPSₙ. Accordingly, MCFA 202 collects data for m iterations of an FPS sequence, where m is selected to yield a frame alignment determination within a given probability of correctness (e.g. 99%).

It should be noted that the FPS need not be comprised of single bits at each bit offset, but that the FPS may include multiple bits at each bit offset.

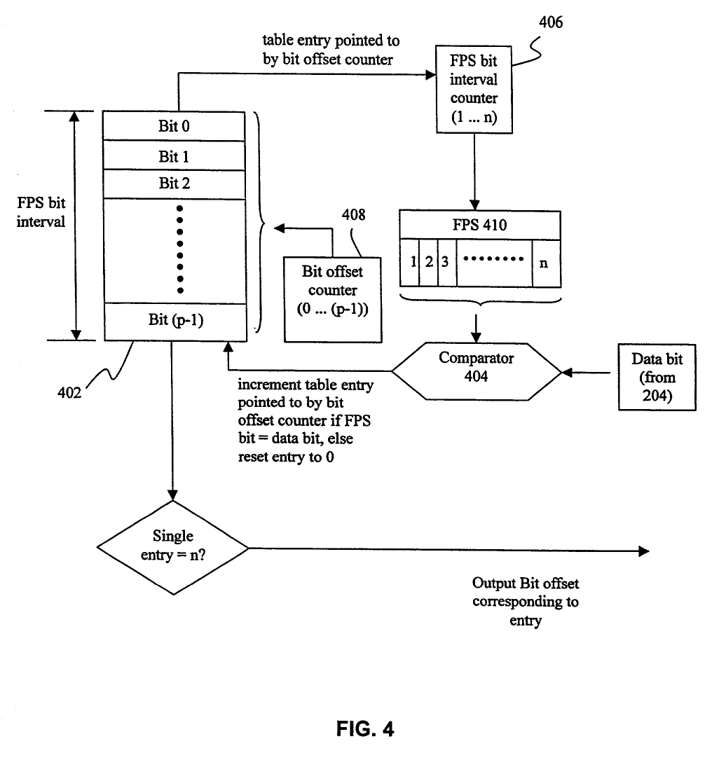

A general operation of MCFA 202 for detecting the FPS bit offset in a data stream for a given channel will now be described with reference to FIG. 4. Although the following describes a frame alignment operation for only one channel for ease of illustration, it is an aspect of the invention that MCFA 202 includes the ability to simultaneously perform frame alignment for up to all channels associated with the MCFA 202 (e.g. by maintaining state tables for all channels). Such aspects of the invention will be described in more detail in following sections of the present specification.

When MCFA 202 receives a request for frame alignment from an inline framer 204, it will set up a state table for the corresponding channel. As shown in FIG. 4, the table 402 includes p entries, one for each bit in a frame bit interval (e.g. 772 for an ESF framing scheme). Each of the entries is initialized to 0, as is the bit offset counter.

Data received from the corresponding channel is examined one bit at a time (in an example where the FPS is comprised of individual bits at each frame bit interval). The comparator 404 compares the received data bit to the FPS bit indicated by the FPS bit interval counter 406. The FPS bit interval counter 406 contains the value of the entry in table 402 pointed to by the bit offset counter 408 plus one (i.e. the next expected bit in the FPS sequence 410). For example, when the first bit is received at each bit offset, the value in the entry corresponding to each bit will be zero, so the received bit is compared to the first FPS bit. Whenever the received data bit matches the expected FPS bit, the entry in state table 402 corresponding to the value of the bit offset counter is incremented. Otherwise, the entry is reset to 0. For example, if the first bit received (i.e. Bit 0) matches the first FPS bit (i.e. 0 plus one), the Bit 0 entry in the table 402 is incremented to 1.

After each received data bit is processed, the bit offset counter 408 is incremented, and after p data bits are received and processed, the bit offset counter is reset. Thus, when the p-th data bit (i.e. Bit p-1) is received, the value of the bit offset counter 408 will be p-1. Accordingly, if the p-th received data bit matches the first FPS bit, the Bit p-1 entry in the table 402 is incremented to 1. After the p-th data bit is processed, the bit offset counter 408 resets to 0. The next received data bit will thus be compared to the next FPS bit in the sequence after the value in the table entry for Bit 0, and if it matches, the Bit 0 entry in table 402 will be incremented by 1. Otherwise, the Bit 0 entry in table 402 will be cleared (i.e. reset to 0).

MCFA 202 thus, in this example of the invention, maintains a running total of the number of sequential matches with the FPS at each bit (or collection of bits) in an FPS bit interval. When the value of any entry in table 402 reaches n, this indicates that one entire FPS was present at the FPS bit offset corresponding to that entry, and the bit offset is reported to the inline framer.

It should be noted, however, that it may take data corresponding to several FPS intervals to be received and processed (i.e. several multiples of, or FPS bit matches greater than, n) for only a single entry to exhibit a frame alignment match due to bit errors and mimics, for example. It should be further noted that the state maintained for a channel can be different than a running total, and may implement other state transition schemes, as will be described in more detail below. It should be even further noted that each channel may simultaneously use different framing schemes, or that all channels may use the same framing scheme, and the MCFA 202 can include the ability to simultaneously detect the same or different framing sequences in a number of channels using the same or different framing schemes.

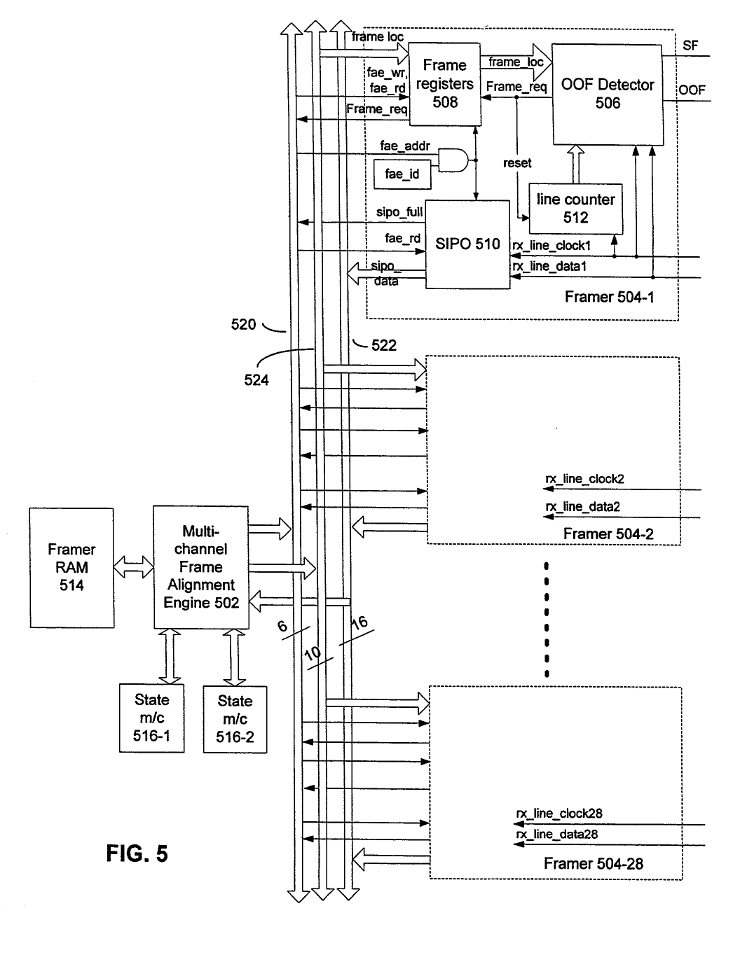

The present invention will now be described in more detail in connection with an example implementation illustrated in FIG. 5. In this example of the invention, ESF is assumed as the framing scheme for all channels. However, those skilled in the art will understand how to extend the principles of the invention to other and/or simultaneously different framing schemes after being taught by the foregoing example, and so the example should not be construed as limiting.

The frame alignment architecture illustrated in FIG. 5 can be implemented, for example, in a portion of an integrated circuit (i.e. channel bank), perhaps along with, or in addition to, other channel and frame processing circuitry, which integrated circuit can be included in a physical layer device coupled to T1 lines, for example. As should be apparent, such a frame alignment architecture and physical layer device can find uses in a variety of applications in association with various points of aggregation including a central office, a digital loop carrier, channel bank, DSU/CSU, Digital Access Cross Connects(DACS), PBX, multiplexors etc.

As shown in FIG. 5, in this example of the invention, multi-channel frame alignment engine (MFAE) 502 is adapted to perform off-line frame alignment for 28 inline framers 504-1 to 504-28. As further shown in FIG. 5, inline framer 504 includes an OOF Detector 506, frame registers 508, serial-in-parallel-out (SIPO) block 510 and line counter 512.

Each inline framer 504 receives a receive line data signal, rx_line_data containing a DS1 time division multiplexed signal. Associated with each line data signal is an rx_line_clk signal that is recovered from the corresponding line data signal using a clock recovery circuit (not shown). At each active edge of rx_line_clk, the rx_line_data signal is serially clocked into serial-in-parallel-out (SIPO) register 510. Each SIPO 510 can be comprised, for example, of two registers of 16 bits each so that while one register is being written, the other is available for reading. SIPO 510 generates a sipo_full signal once all 16 bits are written into the register.

Line counter 512 is comprised of a simple counter that increments from 0 to 771 on each rx_line_clk pulse. It resets to zero after 772 pulses have been received, or when a frame_req signal has been generated by OOF detector 506.

OOF Detector 506, when in frame alignment, monitors the framing bits for bit errors. If the frame bit errors exceed the OOF criteria, a frame_req signal is generated, requesting a fresh frame realignment. For example, given a current frame alignment (i.e. a detected FPS at a given bit offset), OOF detector 506 monitors the continued presence of the FPS at the expected bit offsets. If a certain number of bits in the data stream do not match the FPS at the expected bit offsets over a certain number of repetitions of the FPS, an out of frame condition is assumed. The frame_req signal also resets the line counter 512 to 0.

Frame registers 508 store the frame location (i.e. the bit offset for the FPS) for the associated channel. Frame registers 508 also latch the frame_req signal generated by the OOF detector 506 so that it can be detected by MFAE 502.

Multi-channel Frame Aligner Engine (MFAE) 502 continuously polls all channels sequentially for frame_req and sipo full conditions. This is achieved through the FAE control bus 520 using the fae_addr[4:0], fae_rd and fae_wr signals. These signals generated by MFAE 502 and, generally, all signals on buses 520, 522 and 524, are synchronous to the high speed system clock fae_clk. In order to read or write into an inline framer 504, MFAE 502 uses the word fae_addr[4:0] to output the address of the channel along with a fae_rd or fae_wr signal for one clock cycle on bus 520. Data is read out from an addressed inline framer 504 on read bus 522 via the word fae_data_in[15:0]. Data can be written to an inline framer 504 on write bus 524 via the word fae_data_out[9:0].

An active frame_req signal generated by an inline framer 504 causes MFAE 502 to initiate a search for frame alignment for that channel. The signal is also used to initialize a frame bit counter associated with each channel in the MFAE 502 and maintained in framer RAM. This counter is used to keep track of all 772 frame bit candidates. Because the frame_req signal also resets the line counter 512, the frame bit counter in the MFAE 502 is thus synchronized to the line counter 512 in the corresponding inline framer 504. Once the request for frame alignment is registered for a channel, polling for the sipo full for that channel is started. An active sipo_full condition indicates that 16 bits of data are available for processing. The data bits are read out from the requesting inline framer 504 by addressing the channel through fae_addr and simultaneously asserting fae_rd on control bus 520. The addresses on the fae_addr lines are compared to a hard-wired fae id signal in each of the inline framers 504. The fae_id signal in each framer 504 has a unique value ranging from binary 0 to binary 27. If the address on fae_addr matches that of fae_id for a channel, the data bits stored in SIPO 510 for the channel are driven on read bus 522 via the fae data in word.

The sipo_full signal is asserted by each inline framer 504 once every 16 cycles of the associated rx_line_clk. Since the nominal rx_line_clock rate is 1.544 MHz for DS1, the sipo_full signal will be independently asserted by each inline framer 504 every 10.36 microseconds. To accommodate jitter and frequency variations, which is estimated to be a maximum of 2 UI in 16 clocks, the MFAE 502 should be able to read out data from the SIPO 510 at least once every 9.06 microseconds to avoid SIPO overflow and data loss. In one example implementation of the invention that will be described in more detail below, processing of 16 bits of data by MFAE 502 takes 17 fae_clk cycles. In the worst case, all 28 channels may request for frame alignment, and so 28×17 fae_clk cycles may need to elapse before the next sipo_full indication from the same inline framer 504 can be serviced. Thus, the maximum fae_clk period can be estimated as 9.06/(28×17)=19.03 nanoseconds. In other words, the fae_clk must have a frequency greater than 52.5 MHz in order to process data for all channels in such a worst case scenario without losing data. If the number of channels to be handled is 84 rather than 27 (as in a DS3 framing scheme, for example), then the fae_clk frequency will have to be greater than 158 MHz.

Referring back to FIG. 5, MFAE 502 further communicates with framer RAM 514 and state machines 516-1 and 516-2. Two state machines operate in parallel in this example of the invention for reasons that will be explained in more detail below. However, the invention is not limited to this example, and one or more than two parallel operating state machines may be implemented. The following will describe the operation of one state machine 516, which description will also apply to the other state machine. Further, those skilled in the art will be able to implement the logical structure of state machine 516 after being taught by the following descriptions and the attached drawings.

State machine 516 receives a framing bit candidate's previous state from framer RAM 514 and updates the previous state based on a comparison between the current received data bit and the FPS bit expected to be received (i.e. the next bit in the FPS sequence corresponding to the stored state). For example, if the current stored state indicates that three bits in the FPS sequence have been correctly and sequentially received at that bit position (i.e. a sequence of 001 has already been received in the last three FPS bit intervals at that bit position), then the next expected bit should have a value of 0. Thus, state machine 516 will receive the current stored state and the current received data bit. If the current received data bit has a value of 0, the state machine will output an updated state indicating that four bits in the FPS sequence have been correctly and sequentially received at that bit position. Otherwise, it will output an updated state indicating that the comparison failed.

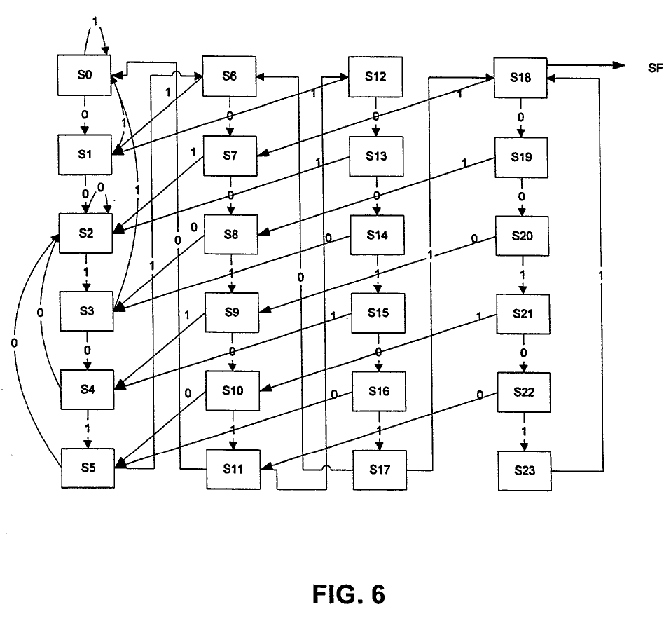

An example of a state transition scheme that can be implemented by state machines 516 is shown in FIG. 6. The state transition diagram is shown for a single bit position in a single channel. As shown in FIG. 6, in this example of the invention, the state for a given bit offset can transition from states S0 to S23. The states S18 to S23 correspond to frame aligned states.

Initially on receipt of a frame_req signal, the default state for each bit position of that channel is S0. The state machine 516 advances the stored state by one state each time a bit received at that bit position corresponds to the expected bit pattern in the FPS (e.g. the ESF Frame pattern sequence of 001011). For example, immediately after starting to collect data for a channel, MFAE 502 causes state machine 516 to start looking for the first bit in the ESF sequence, which is 0. Accordingly, when the first bit for each of the 772 possible bit positions is received, if the value of the received bit is 1 rather than 0, the state for that bit position stays at S0; otherwise, the state for that bit position advances to S1. In the next FPS bit interval of the received data for that channel (i.e. after all other 772 bits have been received and processed for that channel), the next expected bit in the FPS is 0, regardless of whether the state was advanced to S1 or remained at S1. When each subsequent bit is received, state machine 516 also receives the stored state for the corresponding bit offset (either S0 or S1). As shown in FIG. 6, a received data bit of 0 will cause the state machine to advance the corresponding bit position to the next state from both states S0 and S1. Accordingly, if the next received bit for the bit position has a value of 0, the state for that bit position transitions to state S1 or S2 (depending on whether the last received bit had a value of 0 also); otherwise, the state returns to S0 (from either S0 or S1).

After all 6 bits in the FPS have been received correctly in sequence at a given bit position, the stored state for that bit position will have been advanced by state machine 516 to S6. However, in one example of the invention shown in FIG. 6, a further 12 bits having the sequence of 001011001011 must be received correctly to declare a frame alignment at that bit position. Thus, a total of 18 bits must be received correctly and the state for that bit position must have advanced to S18 in order to declare a frame alignment (indicated by the signal SF from state S18). This is because the number of frames required for a 99% correct probability of alignment is 17 for a frame word length n=1 and frame content alpha=0.129%. (Frame content alpha is defined as the fraction of frame alignment word to the total frame capacity. Since there are 6 FPS bits over a frame of 4632 bits in the ESF mode, alpha=6×100/4632=0.129%).

Since each ESF frame bit is separated by 772 bits, the frame length refers to the number of 772 bit frames as sub frames (i.e. the FPS bit interval). Each one of the 772 bits can be a framing bit candidate. Hence state machine 516 compares each received bit with the next FPS bit corresponding to the state stored for the previous 772 frame bit candidate (e.g. if the stored state is S0, S6, S12 or S18, the first FPS bit is compared with the received bit). This is done in parallel by state machines 516-1 and 516-2 for all 772 bit candidates by maintaining 772 states in framer RAM 514. Assuming the worst case condition where the frame_req signal is generated at a bit position one clock after the frame bit position, and that the frame sequence starts at 010110 instead of 001011, a maximum of 24 sub-frames may be required to be received and processed for declaring a frame alignment with the necessary probability of correctness. The frame bit interval corresponds to 772 line clock periods, which is equal to 0.5 ms. This leads to a time (referred to as MART—maximum average reframe time) of 12 ms for frame alignment, which is well within the desired time of 15 ms.

FIG. 6 further illustrates how the state machines 516 can implement a state transition scheme that leads to more rapid frame alignment. In principle, the state transition scheme illustrated in FIG. 6 does always not require a return to state S0 when an unexpected bit is encountered at every other state. Rather, the state returns to a previous state in accordance with a strength of the match with the FPS at that state. For example, as shown in FIG. 6, when the state for a bit position has advanced to S6 (i.e. an entire sequence of the FPS has been received at that bit position), a subsequent non-matching bit causes the state to be returned to S1. However, when the state for a bit position has advanced to S18 (i.e. three entire sequences of the FPS have been consecutively received at that bit position), a subsequent non-matching bit causes the state to only be returned to S7. Thus, only two additional sequences of the FPS need be consecutively received at that bit position for a frame alignment to be declared.

It should be apparent that the state transition scheme illustrated in FIG. 6 is only an example, and that other schemes may be implemented. For example, a strict state transition scheme where all non-matching conditions require a return to state S0 may be implemented. Alternatively, more forgiving state transition schemes may be implemented wherein only a return to a state corresponding to a previous FPS interval is required upon a non-matching condition, for example. Moreover, it should be further apparent that the number of states and the number of iterations of the FPS that must be received for frame alignment can be changed depending on the framing scheme used.

Framer RAM 514 is, for example, a single port burst mode RAM that is organized as 5432 words, each word having 32 bits. This desired capacity is determined from the number of channels that can be aligned in this example implementation (i.e. 28), as well as the number of possible data states that are stored for each framing bit candidate (i.e. 24), as will become more apparent from the descriptions below. It should be noted, however, that the desired capacity of the RAM can be easily designed for different state transition schemes, numbers of channels, and framing schemes, for example, after those skilled in the art are taught by the following descriptions for the present example implementation. It should be further noted that, although a single RAM is used to store the alignment states for all channels in this example implementation, that this is not necessary for the invention.

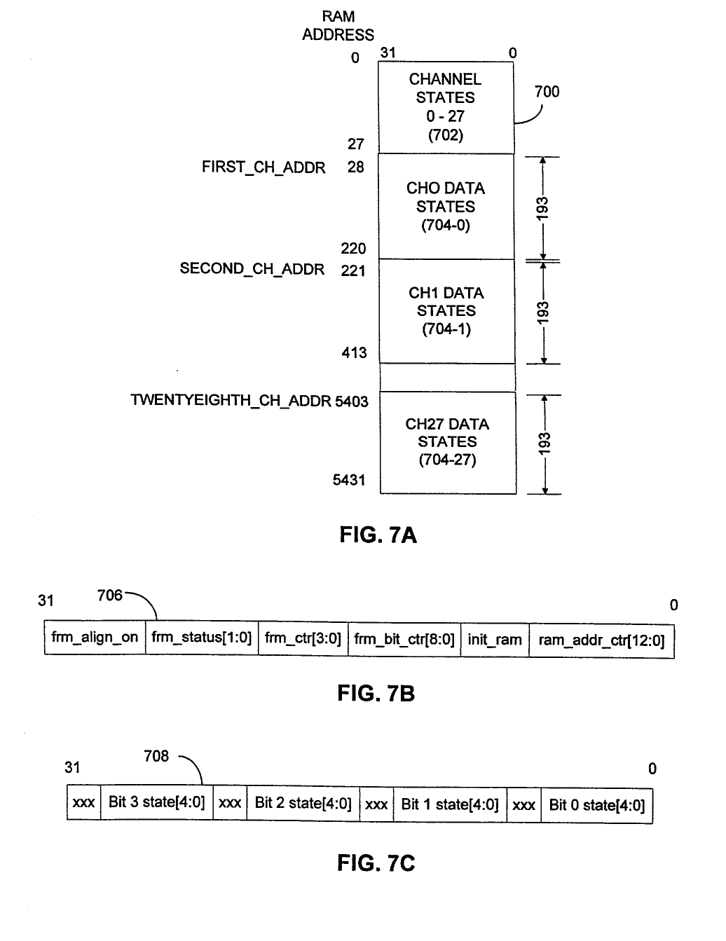

An example of a data structure 700 that can be stored in RAM 514 for maintaining channel frame alignment state information is shown in FIGS. 7A to 7C. As shown in FIG. 7A, block 702 comprises the first twenty-eight words in RAM 514 which are used to store each channel's state variables. An example of the structure of a data word 706 that can be used to store one channel's state variables is shown in FIG. 7B. As shown in FIG. 7B, the state variables maintained for each channel include frm_align_on,frm_status[1:0],frm_ctr[3:0], frm_bit_ctr[8:0], init_ram and ram_addr_ctr[12:0]. The state variable frm_align_on is used to store the current frame alignment status for that channel (e.g. a value of 1 indicates that the channel is in frame alignment). The state variable frm_status[1:0] is used to store the number of FPS patterns detected in a data stream (i.e. the number of entries having a state of 24; this can be more than one due to the possibility of mimics in the data stream). The state variable frm_ctr[3:0] is used to store the number of superframes that have been processed from a data stream. The state variable frm_bit_ctr[8:0] is used to store the number of bits received for a channel, modulo 772. The state variable init_ram is used to store a value of 1 for the first 772 bits received for a channel after a frame_req signal has been received. This is used to cause the state machines to use a hard-wired initial state rather than the stored state so that the RAM need not be re-written with zeroes. The state variable ram_addr_ctr[12:0] is used to store the current RAM index into the data states for the associated data channel from the beginning offset for that channel.

As further shown in FIG. 7A, the remainder of the RAM is divided into 28 blocks 704-0 to 704-27, each block 704 having 193 words for storing the data states for every bit in a respective one of the 28 channels. An example of a data state word structure 708 is shown in FIG. 7C. As shown in FIG. 7C, four data states each having 5 bits are stored in one word. Thus 772 data states (193×4) are stored in memory for each channel. Each data state represents the current ESF frame alignment state of that candidate bit. Since 5 bits are stored for each data bit, up to 32 state conditions can be stored. However, in an example of the invention where the state machines 516 described above are implemented, only 24 state conditions (i.e. S0 to S23) are stored, with a stored value of 0 corresponding to the state S0 up to a stored value of 23 corresponding to state S23.

Although FIGS. 7A through 7C illustrate an example of data structures that can be used to implement storage of alignment states for a predetermined number of channels (e.g. 28) and a predetermined framing format (e.g. ESF), those skilled in the art will be able to understand how to implement storage of alignment states for variable numbers of channels and/or framing formats after being taught by the present example, and so the invention is not limited to these illustrative descriptions.

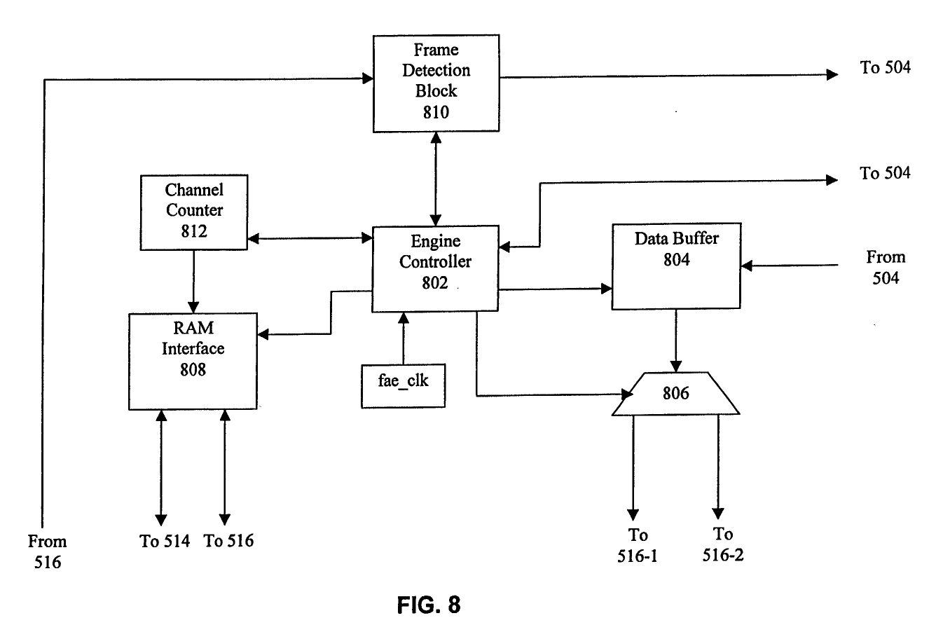

FIG. 8 is a block diagram illustrating an example of MFAE 502 in more detail. As shown in FIG. 8, MFAE 502 includes an engine controller 802, a data buffer 804, a multiplexer 806, a RAM interface 808 , a frame detection block 810 and a channel counter 812.

Generally, engine controller 802 receives and operates at the fae_clk to coordinate the task of performing frame alignment for each of inline framers 504 that has requested alignment. Engine controller 802 cycles through each of the 28 channels in accordance with channel counter 812 (which cycles from 1 to 28). For each channel, engine controller 802 determines whether frame alignment has been requested and if data is available (e.g. by checking the frame req and sipo_full signals for that channel). If so, sixteen bits of data are read from the inline framer on fae_data_in[15:0] from read bus 522 and latched into buffer 804 (e.g. a 16 bit shift register). The received data bits are then serially shifted out two bits at a time. Even bits are diverted to state machine 516-1 and odd bits to state machine 516-2 using the multiplexer 806. Thus for every clock cycle fae_clk, engine controller 802 causes the two state machines 516-1 and 516-2 to receive the previous state in state_in[4:0] from the RAM interface 808 and the data candidate bit from data buffer 804.

Frame detection block 810 monitors the state machines for an indication that a frame alignment has been detected, and generates a frame_sync signal to the associated channel in that case. A frame_bit_ctr maintained in the framer RAM 514 for each channel increments from 0 to 771, which tracks which candidates bit or bits frame detection block 810 provides along with frame_sync signal.

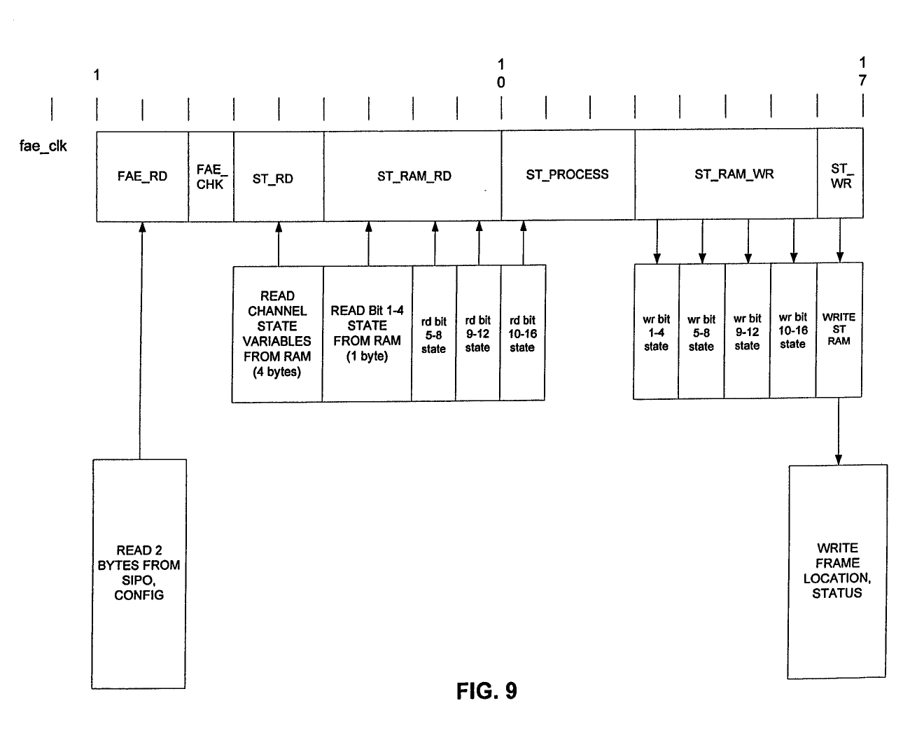

Engine controller 802 can be implemented substantially by a state machine. An example of the operation of engine controller 802 is further illustrated in FIG. 9. Those skilled in the art will be able to implement engine controller 802 based on the following and foregoing operational descriptions.

As shown in FIG. 9, in sequence, engine controller 802 may cycle through up to seven MFAE states for each of the 28 channels in 17 cycles of the fae_clk per channel. In the FAE_RD state, the engine controller 802 reads the SIPO status and data from the channel indicated by channel counter 812. Only if a valid frame_req and sipo_full is received as determined in the FAE_CH state, will the engine controller cycle through the remaining states for that channel. Otherwise, the cycle is aborted, the channel counter is incremented (e.g. from 0 to 27, modulo 28) and the FAE_RD state commences for the next channel.

If valid frame_req and sipo_full signals are received, engine controller 802 causes RAM interface 808 to fetch the channel's previous state variables from the RAM 514's state variable area 702 during the ST_RD state. In the ST_RAM_RD state, engine controller 802 causes the data states for the current 16 bits to be fetched from the data state locations 704 for the associated channel in RAM 514. In the ST_PROCESS state, engine controller 802 causes the ESF state processing to be performed by state machines 516-1 and 516-2 two bits at a time, so as to reduce the number of clock cycles needed to process all 16 bits. Hence two instances of ESF state machines are used in this example of the invention. The updated states from the ESF state machine are stored back into the RAM in the ST_RAM_WR state. Finally, in the ST_WR state, the channel state variables are stored back into the cannel state location in the RAM 514. If frame alignment is achieved, then frame detection block 810 writes the status and frame bit location back into the inline framer 504 via the write bus 524 and word frame_loc. As shown in FIG. 8, engine controller 802 can allow for some overlap of functions between states, thus allowing all 16 bits of received data to be processed in 17 fae_clks.

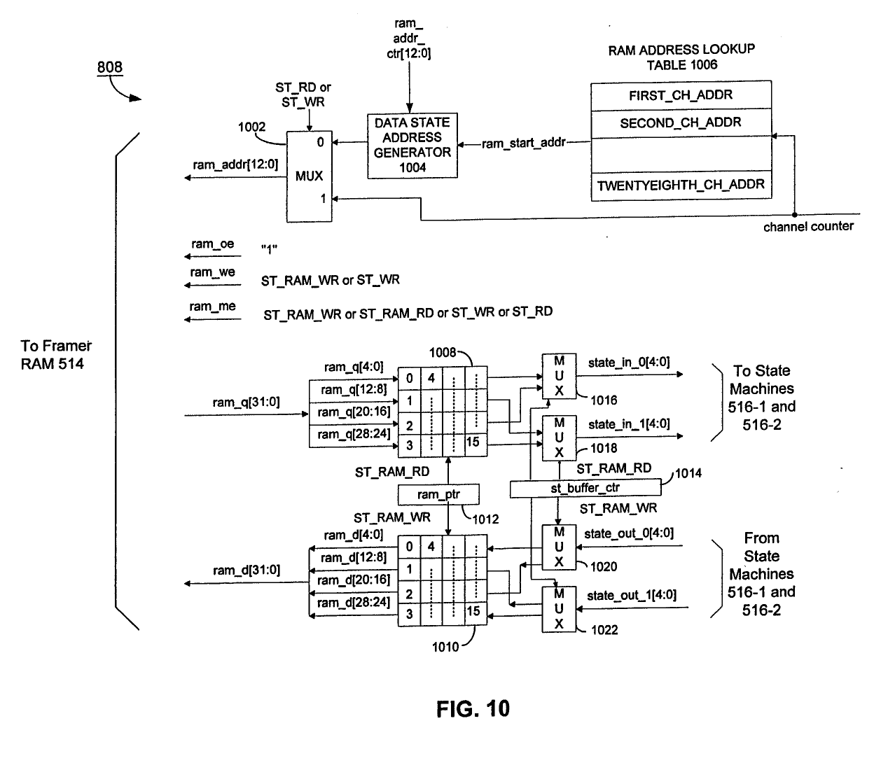

An example of RAM Interface 808 is further shown in FIG. 10. As shown in FIG. 10, it includes address multiplexer 1002, data state address generator 1004, RAM address lookup table 1006, input buffer 1008, output buffer 1010, RAM pointer 1012, buffer counter 1014, input multiplexers 1016, 1018 and output multiplexers 1020, 1022. Generally, RAM interface 808 receives the MFAE states generated by engine controller 802, along with the current channel being processed as indicated by channel counter 812, and controls the writing and reading of channel and data states between framer RAM 514 and state machines 516-1 and 516-2 based on those received inputs. It should be noted that RAM interface 808 preferably also includes circuitry for reading, updating and writing channel state variables from and to the channel state area 702 of RAM 514. However, such circuitry is not shown here for ease of illustration of the present invention.

Referring to FIG. 10, it can be seen that the 13 bit wide ram_addr signals can address either the channel state area or the data state area in the framer RAM 514. More particularly, address multiplexer 1002 selects the channel address generated by channel counter 812 during the ST_RD and SR_WR states (i.e. for addressing the appropriate channel in channel state area 702) and the data state address generator 1004 in other states (i.e. for addressing the appropriate set of data states in data state areas 704). The channel counter increments from 0 to 27 and indicates the current channel or framer being processed. The data state address generator 1004 generates the address for the individual data states located in the data state area of the RAM. The generated address will be a combination of the index into the appropriate data state area obtained from the ram_addr_ctr of the channel state word stored in the RAM as shown in FIG. 7B and the starting address for the channel, ram_start_addr, obtained from RAM address look up table 1006. The data state address generator 1004 will increment the address by one word for every four candidate data bits that are processed. Once 193 words have been read out for a particular channel, the value of ram_addr_ctr will be reset to zero and the value of ram_start_addr from the look up table will be used as the starting address.

In this example implementation of the invention, 16 data bits for each channel are processed at a time. Accordingly, 4 words from the framer RAM 514 are read out in one burst during the ST_RAM_RD cycle. The data state address generation is repeated two times—once in the ST_RAM_RD and once in the ST_RAM_WR cycles. In the ST_RAM_WR cycle the current data states for the 16 bits are written back into the data state area of the memory from the state machines 516-1 and 516-2. In the last MFAE state, ST_WR, the current ram_addr_ctr is stored back into the channel state word as shown in FIG. 7B. Thus for the next cycle of the channel, the data state address generator 1004 will continue to generate addresses from the last accessed location.

RAM interface 808 also generates signals for controlling the reading and writing of data states to RAM 514 depending upon the current MFAE state as provided by the engine controller 802. The RAM output enable signal, ram_oe, is kept permanently enabled. The RAM memory enable signal, ram_me, is driven during ST_RD, ST_WR, ST_RAM_RD, and ST_RAM_WR states. The RAM write enable signal, ram_we, is kept at logic 1 during ST_RAM_WR and ST_WR states when data is being written into the RAM.

The four data state words read out from the RAM beginning at the address generated by the data state address generator 1004 are stored into a 16 location deep and 5 bit wide register array, input buffer 1008, during the ST_RAM_RD state. Four individual 5 bit data states are arranged in each 32 bit data word as shown in FIG. 7C. As shown, the lower 5 bits of each byte in each 32 bit data word contain the data state for a respective candidate bit (e.g. bit 0 to 771 for each channel). The data states read from the RAM during the ST_RAM_RD state are written into a location in input buffer 1008 in accordance with the value of the RAM pointer 1012. The pointer is incremented by 4 every clock during the ST_RAM_RD state. Thus, the first four data states read from the RAM (i.e. from the first data state word addressed by the data state address generator 1014) are written into a first column of the input buffer 1008 on the first clock, the next four data states read from the RAM (i.e. from the second data state word addressed by the data state address generator 1014) are written into a second column of the input buffer 1008 on the second clock, and so on.

Data is read out from input buffer 1008 in a first-in-first-out fashion two data states at a time. Input multiplexers 1016, 1018 redirect five bits of data from an appropriate location in input buffer 1008 into either state machine 516-1 or 516-2. All even data bit states (i.e. states corresponding to Bit 0, Bit 2, Bit 4, etc.) are sent to state machine 516-1 through the state_in_0[4:0] signals, while all odd data bit states (i.e. states corresponding to Bit 1, Bit 3, Bit 5, etc.) are sent to state machine 516-2 through the state in_1[4:0] signals. The reading of the data states out to the state machines is controlled by st_buffer_ctr 1014 which increments from 0 to 7 during the ST_RAM_RD and ST_RAM_WR states. For example, when st_buffer_ctr is 0, input multiplexer 1016 selects a first entry in a first column (i.e. entry 0) to be provided from input buffer 1008 on the state_in_0[4:0] signals, while input multiplexer 1018 selects a second entry in the first column (i.e. entry 1) to be provided from input buffer 1008 on the state_in_1[4:0] signals. Next, when st_buffer_ctr is 1, input multiplexer 1016 selects a second entry in a first column (i.e. entry 3) to be provided from input buffer 1008 on the state_in_0[4:0] signals, while input multiplexer 1018 selects a fourth entry in the first column (i.e. entry 4) to be provided from input buffer 1008 on the state_in_1[4:0] signals. Then, when st_buffer_ctr increments to 2, input multiplexer 1016 selects a first entry in a second column (i.e. entry 4) to be provided from input buffer 1008 on the state_in_0[4:0] signals, while input multiplexer 1018 selects a second entry in the second column (i.e. entry 5) to be provided from input buffer 1008 on the state_in_1[4:0] signals. It should be apparent that this scheme can allow for data to be written into certain locations of input buffer 1008 while data is read out from certain other locations of input buffer 1008.

The processed data states from the two state machines 516-1 and 516-2 are received and written back into RAM 514 by RAM interface 808 in substantially the reverse manner as described above. The processed data states are supplied by state machines 516-1 and 516-2 on the state_out0 and state_out1 signals, respectively. These are stored in output buffer 1010 via output multiplexers 1020, 1022. Output multiplexers 1020, 1022 cause processed data states received via the state_out0 signals to be written into the even locations in the columns of output buffer 1010 while data states received on the state_out1 signals are written into odd locations in the columns of output buffer 1010. During the ST_RAM_WR state, four five-bit data states at a time are written back into RAM 514. The ram_ptr points to the next location to be read from output buffer 1010 and increments by 4 every clock cycle. The four data states are formatted into one 32 bit word as shown in FIG. 7C and written back into the data state area of the RAM 514.

It should be noted that the above descriptions of the timings of operations of various components of RAM interface 808 with respect to the MFAE processing states received from engine controller 802 are given for ease of illustration. However, those skilled in the art will understand that more complex timing schemes may need to be implemented for proper sequence and/or pipelining of operations.

Frame detection block 810 monitors the frame_sync signals from both state machines 516-1 and 516-2 and latches the frame_bit_ctr value into a frame_location[9:0] register if a valid frame_sync signal is received. To avoid framing to a pattern that is random data mimicking the frame alignment pattern, frame detection block 810 is inactive until a minimum number of frames (e.g. 24) have been processed for the channel (as indicated by the frm_ctr word in the channel state variable, for example).

After the requisite number of frames have been processed for a given channel, frame detection block 810 will begin operation after each set of 16 data bits are received from the associated channel. At that time, three scenarios are possible:

1. No frame_sync signal has been generated. The search for a frame alignment is thus continued in the subsequent frames until the first frame alignment is found. This state is saved by setting frm_status[1:0] equal to a value of 0.

2. Only one frame_sync was detected in the entire range of 772 candidate bits. In this case, frame detection block 810 will set frm_status to a value of 1 and assert the frm_align signal. Frame_location[9:0] will indicate the position of the frame bit with respect to the frame_req signal.

3. More than one frame_sync signals is detected within a frame period of 772 bits. This indicates the presence of one or more mimic pattern and is indicated by frm_status having a value of 2. In this case the frame search is continued in subsequent frames until the mimic pattern dies out and only one frame alignment is obtained.

During each cycle in the ST_WR state, a check is made on the frm_status signals. If it has a value of 1, indicating a successful alignment, the frame_location value is written through the common bus fae_data_out[9:0] using the fae_addr[4:0] and fae_wr signals to the corresponding inline framer 504. The inline framer can then use this value to decode all other relevant data bits in the frame.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims include such changes and modifications.

What is claimed is:

1. An apparatus for simultaneously determining a respective frame alignment in each of a plurality of channels, the apparatus comprising:
means for simultaneously storing a frame alignment state for a plurality of frame bit candidates for each of the plurality of channels;
means for receiving data from the plurality of channels;
means for updating the stored frame alignment state for each of the plurality of frame bit candidates in accordance with the received data; and
means for declaring the respective frame alignment in accordance with the updated frame alignment state for a certain one of the plurality of frame bit candidates for each of the plurality of channels.

2. An apparatus according to claim 1, wherein the updating means includes:
means for retrieving the frame alignment state for certain of the frame bit candidates associated with the received data;
means for comparing the received data with expected framing data based on the retrieved frame alignment states;
means for advancing the retrieved frame alignment states upon a successful comparison of the received data with the expected framing data;
means for withholding advancing of the retrieved frame alignment states upon a failed comparison of the received data with the expected framing data; and
means for replacing the retrieved frame alignment states with the updated frame alignment states in the storing means.

3. An apparatus according to claim 2, wherein the withholding means is operative to reset the retrieved frame alignment states to less advanced states in accordance with current frame alignment strengths indicated by the retrieved frame alignment states.

4. An apparatus according to claim 1, further comprising:
means for polling the plurality of channels for frame alignment requests; and
means for controlling the operation of the receiving means, the updating means and the declaring means for certain of the plurality of channels based on the polled frame alignment requests.

5. An apparatus according to claim 4, wherein each of the plurality of channels includes an inline framer, the inline framer comprising:
means for generating the frame alignment request; and
means for processing channel data using an old frame alignment simultaneously while the respective frame alignment is being determined.

6. An apparatus according to claim 1, wherein the respective frame alignment for a first one of the plurality of channels is in accordance with a first framing scheme, and wherein the respective frame alignment for a second one of the plurality of channels is in accordance with a second framing scheme, the first and second framing schemes both being one of DS1 SF, DS1 DDS, DS1 SLC-96, and ITU-T G.704 based E1.

7. An apparatus according to claim 1, wherein the respective frame alignment for a first one of the plurality of channels is in accordance with a first framing scheme, and wherein the respective frame alignment for a second one of the plurality of channels is in accordance with a second framing scheme, the first and second framing schemes each being a different one of DS1 SF, DS1 DDS, DS1 SLC-96, and ITU-T G.704 based E1.

8. A method for simultaneously determining a respective frame alignment in each of a plurality of channels, the apparatus comprising:
simultaneously storing a frame alignment state for a plurality of frame bit candidates for each of the plurality of channels;
receiving data from the plurality of channels;
updating the stored frame alignment state for each of the plurality of frame bit candidates in accordance with the received data; and
declaring the respective frame alignment in accordance with the updated frame alignment state for a certain one of the plurality of frame bit candidates for each of the plurality of channels.

9. A method according to claim 8, wherein the updating step includes:
retrieving the frame alignment state for certain of the frame bit candidates associated with the received data;
comparing the received data with expected framing data based on the retrieved frame alignment states;
advancing the retrieved frame alignment states upon a successful comparison of the received data with the expected framing data;
withholding advancing of the retrieved frame alignment states upon a failed comparison of the received data with the expected framing data; and
replacing the retrieved frame alignment states with the updated frame alignment states.

10. A method according to claim 9, wherein the withholding step includes resetting the retrieved frame alignment states to less advanced states in accordance with current frame alignment strengths indicated by the retrieved frame alignment states.

11. A method according to claim 8, further comprising:
polling the plurality of channels for frame alignment requests; and
controlling performance of the receiving step, the updating step and the declaring step for certain of the plurality of channels based on the polled frame alignment requests.

12. A method according to claim 11, wherein each of the plurality of channels includes an inline framer, the method further comprising:
processing channel data at the inline framer using an old frame alignment simultaneously while the respective frame alignment is being determined.

13. A method according to claim 8, wherein the respective frame alignment for a first one of the plurality of channels is in accordance with a first framing scheme, and wherein the respective frame alignment for a second one of the plurality of channels is in accordance with a second framing scheme, the first and second framing schemes both being one of DS1 SF, DS1 DDS, DS1 SLC-96, and ITU-T G.704 based E1.

14. A method according to claim 8, wherein the respective frame alignment for a first one of the plurality of channels is in accordance with a first framing scheme, and wherein the respective frame alignment for a second one of the plurality of channels is in accordance with a second framing scheme, the first and second framing schemes each being a different one of DS1 SF, DS1 DDS, DS1 SLC-96, and ITU-T G.704 based E1.

15. An apparatus, comprising:
a frame alignment engine coupled to a bus for commonly receiving data from a plurality of channels, the received data from each of the plurality of channels including a framing pattern embedded at a frame bit offset with respect to an arbitrary starting bit of a stream of data respectively associated with each of the plurality of channels;
a memory coupled to the frame alignment engine, the memory having a plurality of channel state entries respectively corresponding to the plurality of channels, each of the channel state entries including a counter referenced to the arbitrary starting bit, the memory further having a plurality of data state entries for each of the plurality of channels, the plurality of data state entries respectively corresponding to a plurality of frame bit candidates, the frame alignment engine being responsive to data received from a requesting one of the channels so as to retrieve the counter for the requesting channel, and to retrieve certain of the data state entries corresponding to the received data from the requesting channel based on the counter; and
a state machine coupled to the frame alignment engine, the state machine including a comparator that is adapted to compare the data received from the requesting channel with the framing pattern and to update the certain data state entries based on the comparison.

16. An apparatus according to claim 15, wherein each of the plurality of channels includes an inline framer, the inline framer comprising:
a frame register for storing an old frame bit offset;
an out of frame detector coupled to the frame register for processing the respective stream of data using the old frame bit offset simultaneously while the respective frame bit offset is being determined.
